(19) United States
(12) Patent Application Publication
(10) Pub. No.: US 2025/0213405 A1
(43) Pub. Date: Jul. 3, 2025

(54) SMART LOCOMOTORY ASSISTIVE DEVICE (SLAD)

(71) Applicant: SRUTHI BABU, Coimbatore (IN)

(72) Inventors: SRUTHI BABU, Coimbatore (IN); K. K BABU, Coimbatore (IN); k Ramakrishnan, Coimbatore (IN)

(21) Appl. No.: 19/047,658

(22) Filed: Feb. 7, 2025

Related U.S. Application Data
(63) Continuation-in-part of application No. 17/420,527, filed on Jul. 2, 2021, now abandoned.

(30) Foreign Application Priority Data
Apr. 14, 2019 (IN) 201941015140

(51) Int. Cl. A61G 5/10; A61G 5/00; A61G 5/12; A61G 7/02

(52) U.S. Cl. CPC A61G 5/1002; A61G 5/006; A61G 7/02; A61G 5/121; A61G 5/122; A61G 5/128

(57) ABSTRACT

The present invention describes a smart locomotory assistive device 1000 (or SLAD 1000) to assist the patient for a defecation cycle and locomotion. The SLAD 1000 reduces the level of dependency of patients by providing a wheelchair cum bed with automatic defecation, easy collecting, hygiene cleaning and leak proof packing process for the comfortable defecation in a defecation cycle.

### FIELD OF THE INVENTION

The present invention in general, relates to assistive devices. More particularly, a device and method is described for assisting a patient for defecation and locomotion.

### BACKGROUND OF THE INVENTION

The mobility impairment or the disability is the most common issue in many patients that affect their ADLs (activities of daily living) making them completely dependent on the caretakers (ward boys and/or nurses). Besides, each day managing the patients in the hospitals and/or at home involves many people as they need round the clock assistance for their continuous care.

This becomes more critical when a large number of patients turn up in the hospitals. It is estimated that 421 million patients are hospitalized in the world annually (WHO, 10 facts on patient safety, Updated March 2018). And, attending to their daily needs is an everyday challenge. Further, employing a large number of caretakers proves to be uneconomical and managing them adds even more to the challenge.

The other problem associated after hospitalization is the physical pain endured by mobility impaired patients when they are displaced for the ADLs. The patients during the transfer (for defecation to maintain the hygiene) are subjected to the increased chances of injuries. Besides, the patients undergo mental stress when finding themselves helpless in performing the ADLs.

In view of the foregoing, there is a need for motor dysfunction, immobile, and elderly patients to make their ADLs and defecation process much easier. The aim of the invention is to provide a system for effectively eliminating the physical and social issues existing due to mobility impairment.

The applicant has devised, tested and embodied the present invention “Smart Locomotory Assistive Device (SLAD)” to overcome the problems described above and to assist patients for performing their activities of daily living independently.

### SUMMARY OF THE INVENTION

The object of the present invention is to provide a smart locomotory assistive device for automatic defecation cleaning to assist users.

To achieve the aforementioned object, the smart locomotory assistive device for automatic defecation cleaning of a user comprises a seat opening assembly configured to cover or uncover an opening for defecation; a container handling module configured to operate at least one container, wherein the at least one container is configured to collect a fecal matter; a wiping module configured to perform a cleaning operation to the user, wherein said wiping module comprises: (a) a tissue holding assembly configured to expose a cleaning material to perform the cleaning operation; and (b) a wiping assembly; a lid module configured to close the at least one container using at least one lid; and a control unit configures to control the seat opening assembly, the handling control module, the wiping module and the lid assembly.

According to another object of the invention, the seat opening assembly comprises a seat door pivotally connected to a seat guide shaft.

According to yet another object of the invention, the container handling module comprises a container releasing assembly, a container holding assembly, a container loading assembly or combination thereof.

According to yet another object of the invention, the tissue holding assembly comprises at least one tissue holding arm, at least one base plate, at least one tissue holding compartment or combination thereof.

According to yet another object of the invention, the tissue holding arms comprises at least one cleaning material exposed thereon to perform cleaning operation.

According to yet another object of the invention, the cleaning material can include at least one selected from tissues, wipes, clothes, paper clothes, cotton or the like.

According to yet another object of the invention, the tissue holding assembly configured to expose a cleaning material to perform the cleaning operation; and

According to yet another object of the invention, the wiping assembly is configured to be mounted to the tissue holding assembly so as to move it in at least one of three X, Y, or Z directions.

According to yet another object of the invention, the lid module comprises a lid positioning assembly, a lid closing assembly or combination thereof.

According to yet another object of the invention, the lid positioning assembly comprises at least one lid base with stacked plurality of lids and at least one container lid press plate.

According to yet another object of the invention, the lid closing assembly assists the container lid press plate for locking the container with the lid.

According to yet another object of the invention, the device of the present invention comprises a head portion, a mid portion and a foot portion.

According to yet another object of the invention, the seat opening assembly, the container handling module, the wiping module, the lid module and the control unit are installed on at least one selected from the head portion, the mid portion, the foot portion or combination thereof.

According to yet another object of the invention, the said device is selected from a convertible bed cum chair, a wheelchair, a bed, a chair, a stretcher, a gurney or the like.

According to yet another object of the invention, the control unit is configured to operate, control and monitor the device using one or more sensors.

According to yet another object of the invention, the control unit is configured to receive the input by at least one input interface selected from a touchpad, keyboard, buttons, touchscreen, joysticks, keypads, voice command or the like.

According to yet another object of the invention, the control unit is configured to receive an input for repetition of at least one of the operations of the device, preferably the operation related to the wiping module.

According to yet another object of the invention, the containers are sealable biodegradable containers such as made of banana starch for easy and early decomposition.

According to yet another object of the invention the containers are zipper lock bags.

According to yet another object of the invention the containers are disposable containers.

According to yet another object of the invention, the device further comprises a small water jet tubing to spray water for cleaning.

According to yet another object of the invention, the bidet module is utilized for cleansing process.

According to yet another object of the invention, the tissue holding assembly further comprises a step where the user is sterilized with hot air blow.

According to yet another object of the invention is to provide a smart locomotory assistive device which can be converted into a bed.

According to yet another object of the invention is to provide a smart locomotory assistive device which can be converted into a wheelchair.

### BRIEF DESCRIPTION OF THE DRAWINGS

The features and advantages of the present invention will become apparent upon consideration of the following detailed description of embodiments thereof, especially when taken in conjunction with the accompanying drawings, and wherein:

FIG. 1A-1B schematically illustrates a smart locomotory assistive device 1000 according to an embodiment of the invention;

FIG. 2A illustrates a perspective view of a seat opening assembly 100 according to embodiments of the invention;

FIG. 2B is an exploded view of the seat opening assembly 100;

FIG. 3A illustrates a perspective view of a container releasing assembly 200 according to embodiments of the invention;

FIG. 3B is an exploded view of the container releasing assembly 200;

FIG. 4A illustrates a perspective view of a container holding assembly 300 according to embodiments of the invention;

FIG. 4B is an exploded view of the container holding assembly 300;

FIG. 5A illustrates a perspective view of a container loading assembly 400 according to embodiments of the invention;

FIG. 5B is an exploded view of the container loading assembly 400;

FIG. 6 illustrates an exploded view of a tissue holding assembly 500 according to embodiments of the invention;

FIG. 7 illustrates an exploded view of a wiping assembly 600 according to embodiments of the invention;

FIG. 8 illustrates a perspective view of the wiping assembly 600 with the tissue holding assembly 500 according to embodiments of the invention;

FIG. 9 illustrates a perspective view of a lid positioning assembly 700 according to the embodiment of the invention;

FIG. 10A illustrates a perspective view of a lid closing assembly 800 according to embodiments of the invention;

FIG. 10B is an exploded view of the lid closing assembly 800;

FIG. 11 schematically shows a smart locomotory assistive device 1000 according to another embodiment of the invention;

FIG. 12 schematically shows an example flow diagram of a method 1100 for orientation of the SLAD 1000 from a bed mode to a wheelchair mode according to another embodiment of the invention;

FIG. 13 schematically shows another example flow diagram of a method 1200 describing the working of the SLAD 1000 according to another embodiment of the invention; and

FIG. 14 schematically shows another example flow diagram of a method 1300 for orientation of the SLAD 1000 from a wheelchair mode to a bed mode according to another embodiment of the invention.

### DETAILED DESCRIPTION OF THE PREFERRED EMBODIMENT

Aspects of the present invention are best understood by reference to the figures and description set forth herein. All the aspects described herein will be better appreciated and understood when considered in conjunction with the following description and the accompanying drawings. It should be understood, however, that the following descriptions, while indicating preferred aspects and numerous specific details thereof, are given by way of illustration and not of limitation. Many changes and modifications may be made within the scope herein without departing from the spirit and scope thereof, and the present invention herein include all such modifications.

Several aspects of the present invention are disclosed herein. It is to be understood that these aspects may or may not overlap with one another. Thus, part of one aspect may fall within the scope of another aspect, and vice versa. Each aspect is illustrated by a number of embodiments, which in turn, can include one or more specific embodiments. It is to be understood that the embodiments may or may not overlap with each other. Thus, part of one embodiment, or specific embodiments thereof, may or may not fall within the ambit of another, or specific embodiments thereof, and vice versa.

A broad framework of the principles will be presented by describing various embodiments of this invention using exemplary aspects and represented in different drawing figures. For clarity and ease of description, each aspect includes only a few embodiments. Different embodiments from different aspects may be combined or practiced separately, to design a customized process depending upon application requirements. Many different combinations and sub-combinations of a few representative processes shown within the broad framework of this invention, that may be apparent to those skilled in the art but not explicitly shown or described, should not be construed as precluded.

This disclosure is generally drawn, inter alia, to apparatuses, systems, and mechanisms describing a “Smart Locomotory Assistive Device”, an assistive device to enhance the activities of daily living (or ADLs) of mobility impaired patients in terms of locomotion and defecation or toileting.

For the specification, the term preset angle of rotation is defined as the angle of rotation through which the elements, parts, portions, components, units, member, or the like of the SLAD 1000 rotate about different axis of rotation when the SLAD 1000 orients itself from a bed mode to a wheelchair mode or from a wheelchair mode to a bed mode, and defecation cycle is defined as the cycle in which the SLAD 1000 assists the patient for defecation.

Still further, sensors, controllers, and the like may be used for more than one control and monitoring function. Still further, applications, monitoring functions, and control functions may be selected and configured on the system to perform different types of control and monitoring tasks using one or more sensors or control devices.

The Smart Locomotory Assistive Device 1000, hereinafter SLAD 1000, provides a wheelchair cum bed with automatic defecation, easy collecting, hygiene cleaning and fool proof packing process for the comfortable defecation for the patients thereby, reducing the work of a caretaker.

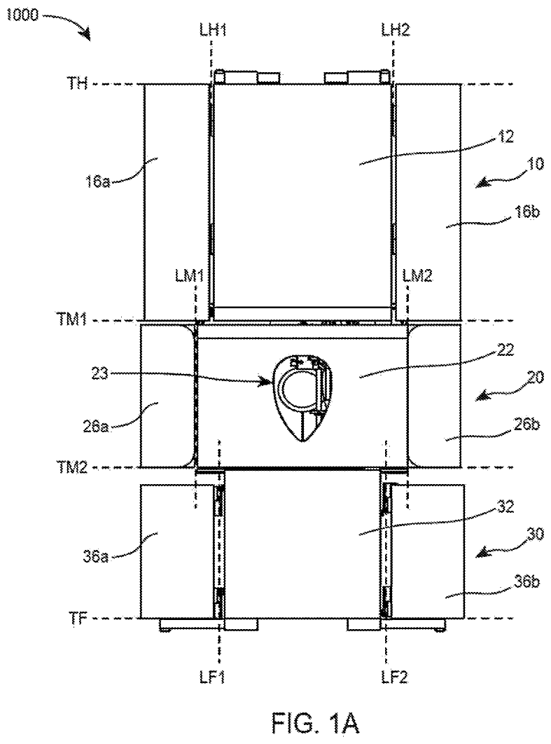

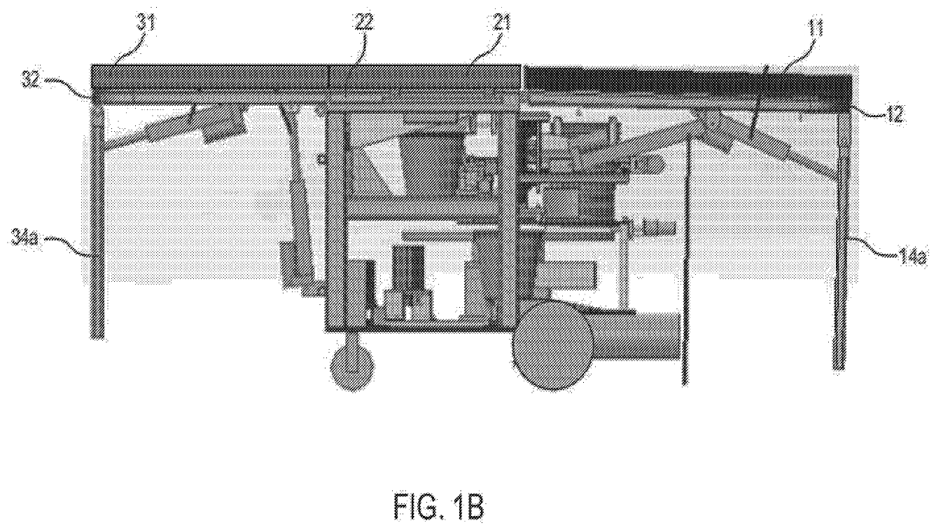

With reference to FIG. 1A and 1B, the SLAD 1000 is described according to an embodiment of the invention. The FIG. 1A shows the top view of the SLAD 1000 in a bed mode. The SLAD 1000 is structured in the shape of a bed as shown in FIG. 1B. The SLAD 1000 comprises a head portion assembly 10, a mid portion assembly 20, a foot portion assembly 30, and a control unit 50 (not shown). The head portion assembly 10 further comprises a head bottom portion 12 configured to provide structural rigidity to the SLAD 1000. A head supporting frame 14 (not shown) having a pair of legs 14a and 14b is coupled with the head bottom portion 12. In one specific example, the coupling is made with a joint configuring the pair of legs 14a and 14b to rotate and translate about an axis TH, wherein the axis TH is the transverse axis of the head bottom portion 12 (shown in FIG. 1A). In another example, the pair of legs 14a and 14b are coupled with a rotational joint (R joint) to only rotate about the axis TH of the head bottom portion 12.

According to another embodiment of the invention, the rotation of the pair of legs 14a and 14b is enabled with the linear actuators. The linear actuators are controlled by the control unit 50.

According to yet another embodiment of the invention, a head top portion 11 is configured on the head bottom portion 12 to cushion the patient.

According to yet another embodiment of the invention (as shown in FIG. 1A), a pair of head side spacer 16 are also coupled with the head bottom portion 12 with a rotational joint (R joint) configuring a head side spacer 16a of the pair of head side spacer 16 to rotate about an axis LH1, wherein an axis LH1 is the longitudinal axis perpendicular to the axis TH. Similarly, a head side spacer 16b of the pair of head side spacer 16 is coupled to rotate about an axis LH2, wherein the LH2 is another longitudinal axis perpendicular to the axis TH and parallel to the LH1. The axes LH1, LH2, TH all lie in the plane of the head bottom portion 12.

According to yet another embodiment of the invention, the head side spacers 16a and 16b are configured with a cushioning liner to cushion the patient.

The mid portion assembly 20 comprises a mid bottom portion 22, a supporting frame 24 having a plurality of legs, and a pair of hand resting spacer 26. The mid bottom portion 22 is fixed on the supporting frame 24 (not shown) and is coupled with the head bottom portion 12 with a rotational joint (R joint) configuring the head bottom portion 12 to rotate about an axis TM1 through the preset angle of rotation, wherein the axis TM1 is a transverse axis of the mid bottom portion 12 (as shown in FIG. 1A). In one specific example, the rotation of the head bottom portion 12 about the axis TM1 is enabled with the linear actuators. Further an opening 23 is provided in the mid bottom portion 22 and is designed to facilitate both male and female patients defecation process.

According to another embodiment of the invention, the linear actuators for the rotation of the head bottom portion 12 about the axis TM1 are controlled by the control unit 50.

In yet another embodiment, a mid top portion 21 is configured on the mid bottom portion 22 to cushion the patient.

In yet another embodiment of the invention, a hand resting spacer 26a of the pair of hand resting spacer 26 is coupled with the mid bottom portion 22 with a rotational joint (R joint) configuring the hand resting spacer 26a to rotate about an axis LM1, wherein the axis LM1 is a longitudinal axis of the mid bottom portion 12 perpendicular to the axis TM1 (as shown in FIG. 1A). Similarly, a hand resting spacer 26b of the pair of hand resting spacer 26 is coupled with a rotational joint to rotate about an axis LM2, wherein the axis LM2 is another longitudinal axis of the mid bottom portion 12 perpendicular to the axis TM1 and parallel to the axis LM1. The axes LM1, LM2, TM1, all lie in the plane of the mid bottom portion 22.

In yet another embodiment of the invention, the hand resting spacers 26a and 26b are configured with a cushioning liner to cushion the patient.

In yet another embodiment of the invention, the mid portion assembly 10 comprises drive wheels and driven wheels coupled to the plurality of legs of the supporting frame 24. The driving wheels and the driven wheels help the SLAD 1000 for easy transfer of the patient from one room to another. In one example (not shown), a DC motor attached to gear box coupled to the driving wheels is used as a drive mechanism. In another example, two separate motors and gear box for left and right side driving wheels are used. The driven wheels are idle and are driven via the driving wheels. In one example, the DC motor is controlled by the control unit 50 based on the received inputs from the input interface operated either by the patient or the caretaker.

The foot portion assembly 30 comprises a foot bottom portion 32, a foot supporting frame 34 (not shown), and a pair of foot side spacer 36. The foot bottom portion 32 is coupled with mid bottom portion 22 with a rotational joint at an axis TM2, wherein the axis TM2 is another transverse axis of the mid bottom portion 12 parallel to the axis TM1 of the mid bottom portion 12, configuring the foot bottom portion 32 to rotate about an axis TM2.

According to another embodiment of the invention, the rotation of the foot bottom portion 32 about the axis TM2 is enabled with the linear actuators controlled by the control unit 50.

The foot supporting frame 34 having a pair of legs 34a and 34b is coupled with the foot bottom portion 32. In one specific example, the coupling is made with a joint configuring the pair of legs 34a and 34b to rotate and translate about an axis TF, wherein the TF is a transverse axis of the foot bottom portion 32 (as shown in FIG. 1A). In another example, the pair of legs 34a and 34b are coupled with a rotational joint (R joint) to only rotate about the axis TF of the foot bottom portion 32.

According to another embodiment of the invention, the pair of legs 34a and 34b is enabled with the linear actuators. The linear actuators are controlled by the control unit 50.

According to yet another embodiment of the invention, a foot top portion 31 is configured on the foot bottom portion 32 to cushion the patient.

According to yet another embodiment of the invention, a foot side spacer 36a of the pair of foot side spacer 36 is coupled with the foot bottom portion 32 with a rotational joint (R joint) configuring the foot side spacer 36a to rotate about an axis LF1, wherein the axis LF1 is a longitudinal axis of the foot bottom portion 32 (as shown in FIG. 1A). Similarly, a foot side spacer 36b of the pair of foot side spacer 36 rotates about an axis LF2, wherein the LF2 is another longitudinal axis perpendicular to the axis TF and parallel to the axis LF1 of the foot bottom portion 32. The axes LF1, LF2, TF all lie in the plane of the foot bottom portion 32.

According to yet another embodiment of the invention, the foot side spacers 36a and 36b are configured with a cushioning liner to cushion the patient.

According to yet another embodiment of the invention, the head portion assembly 10, the mid portion assembly 20, and the foot portion assembly 30 are made of mild steel. However, other suitable materials for example, aluminium, rubber, plastic, fiber, etc, as obvious to a person skilled in the art, can also be utilized.

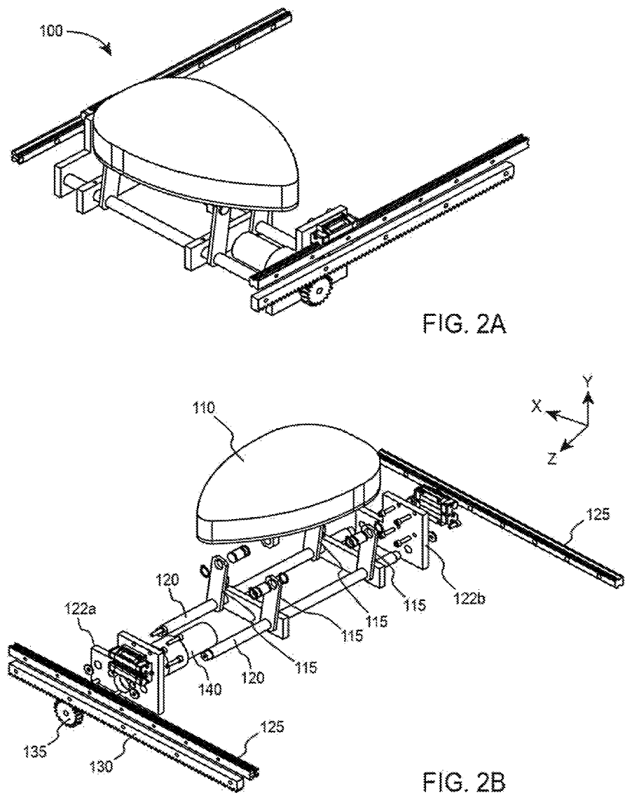

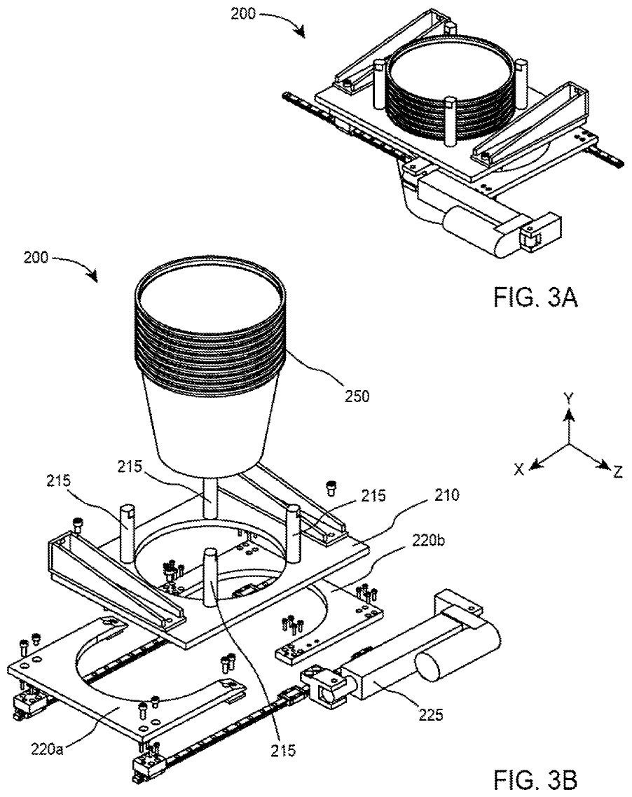

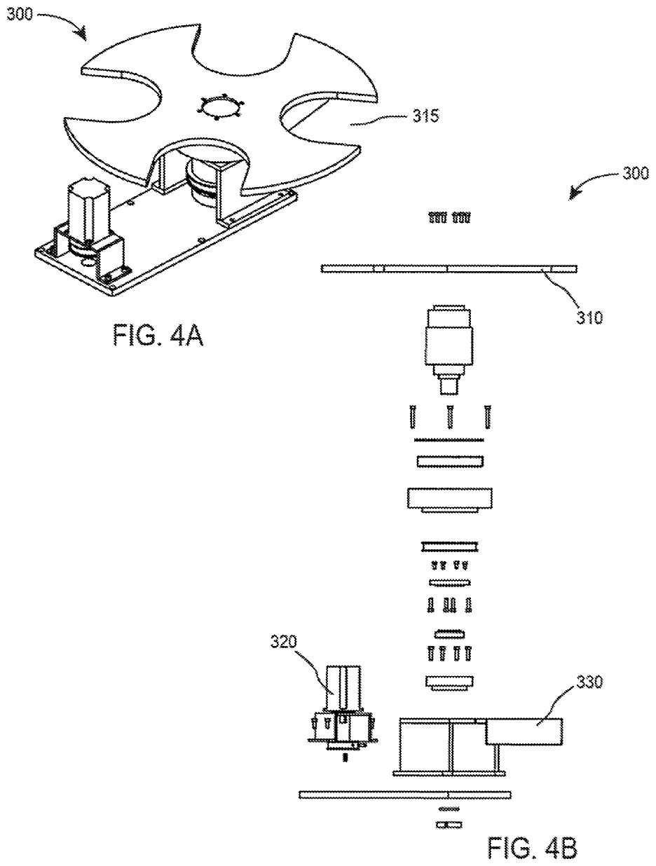

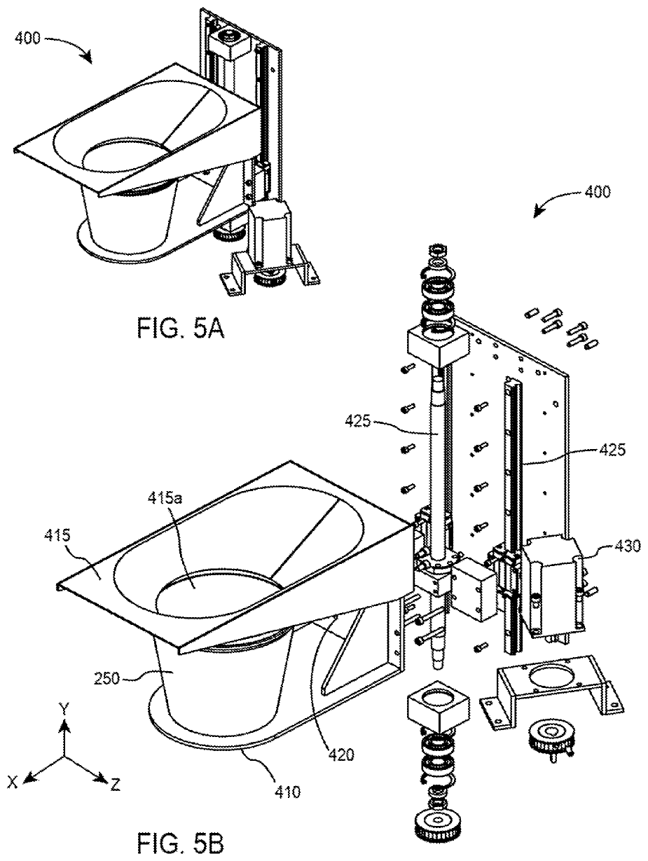

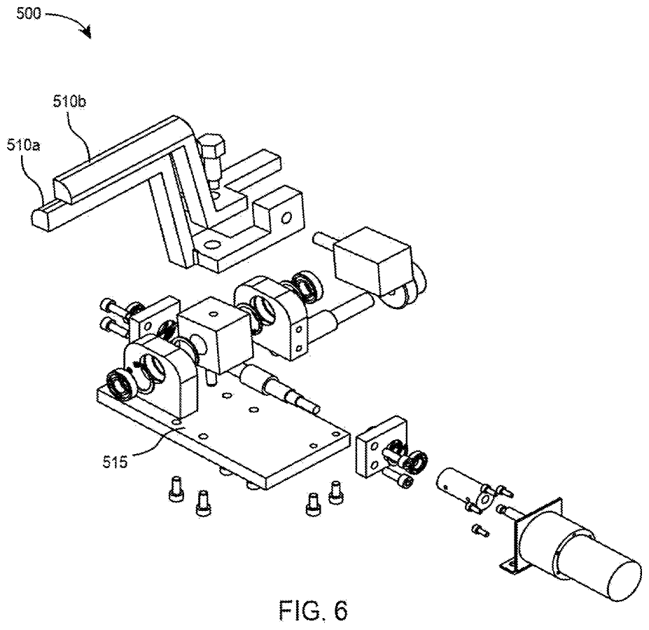

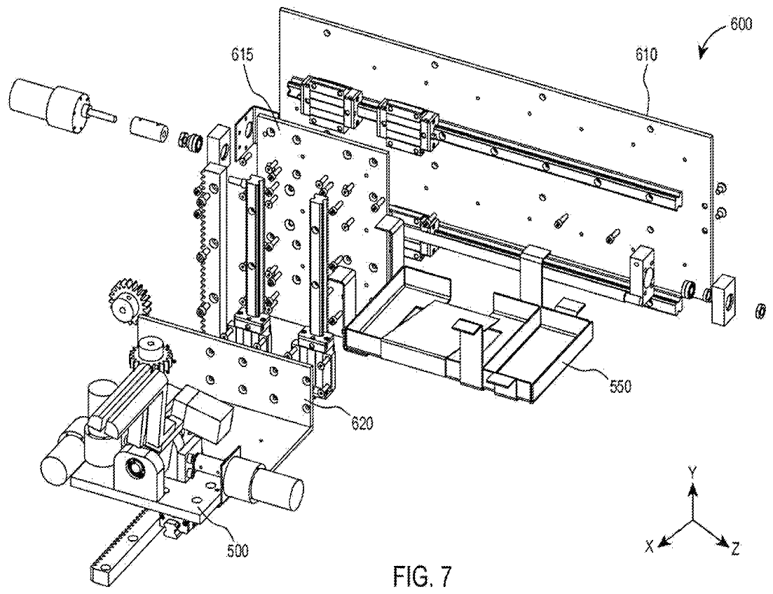

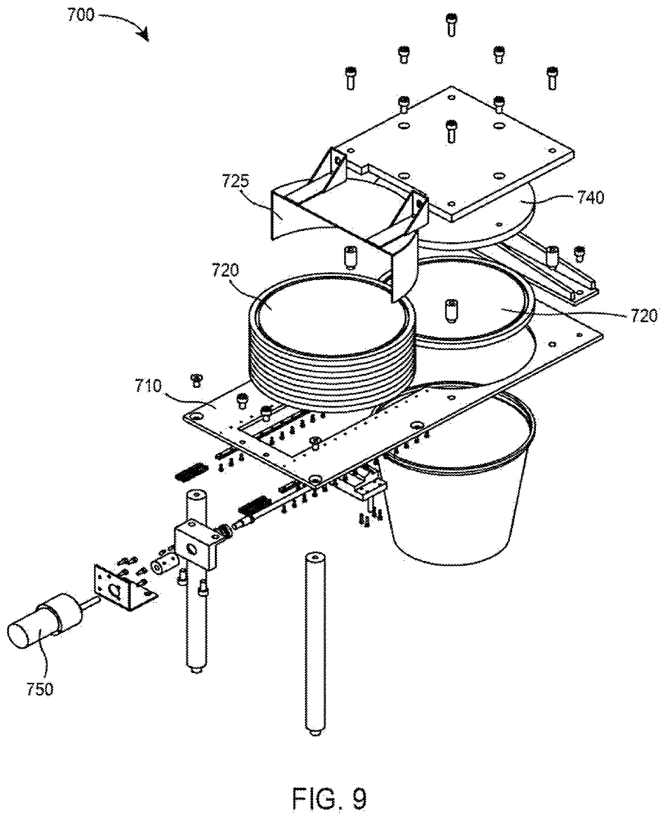

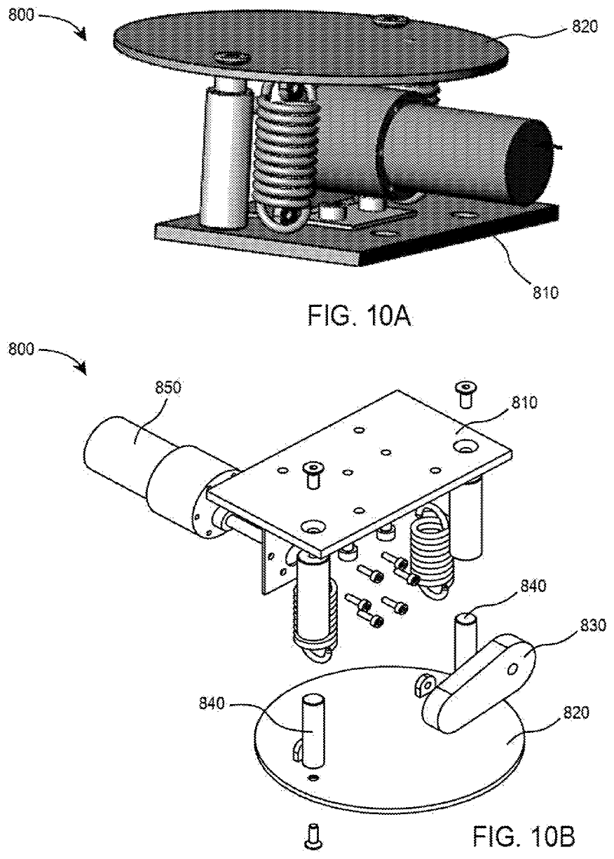

According to yet another embodiment of the invention, the SLAD 1000 further comprises a seat opening assembly 100 (FIG. 2A-2B), a container releasing assembly 200 (FIG. 3A-3B), a container holding assembly 300 (FIG. 4A-4B), a container loading assembly 400 (FIG. 5A-5B), a tissue holding assembly 500 (FIG. 6), a wiping assembly 600 (FIG. 7), a lid positioning assembly 700 (FIG. 9), a lid closing assembly 800 (FIG. 10A-10B) coupled below the mid bottom portion 22 and the head bottom portion 12.

The seat opening assembly 100, as shown in FIG. 2B, covers or uncovers the opening 23 in the mid top portion 22 for defecation. The seat opening assembly 100 comprises a seat door 110 connected to seat guide shaft(s) 120 via connecting link(s) 115. The ends of the seat guide shaft(s) 120 are connected to side plates 122a and 122b attached to slider(s) on different rail(s) 125. The seat opening assembly 100 is configured in this way so as to move the seat door 110 downwards away from the patient considering the patient's comfort.

When the slider(s) move in X-axis, it displaces the seat guide shaft(s) 120 in the same direction. This translation of the seat guide shaft(s) 120 causes the connecting link(s) 115 to rotate downwards, thereby lowering the seat door 110. A rack 130 and pinion 135 enables the seat guide shaft(s) 120 to slide in X-axis. The pinion 135 is driven by a motor 140 to move the seat door 110 in X-axis. The motion is retraced to raise the seat door 11.

In another embodiment of the invention, the motor 140 is controlled by the control unit 50 to move the seat door 110.

According to yet another embodiment of the invention, the container handling module (not shown) comprises the container releasing assembly 200, the container holding assembly 300 and the container loading assembly 400.

The container releasing assembly 200, with reference to FIG. 3B, comprises a container loading plate 210, container holding rods 215, container releasing plates 220a and 220b. The container releasing plate 220a is configured to translate in a X-direction via a linear drive actuator 225. A plurality of containers 250 are stacked and loaded in the container loading plate 210. The container holding rods 215 align the containers 250 for the efficient release of the container 250.

The container releasing assembly 200 stores the plurality of container 250. The containers 250 are the sealable receptacles utilized for collecting the fecal matter and urine of the patient.

In another embodiment of the invention, the container 250 are biodegradable containers utilized in the defecation process. In one specific example, the biodegradable containers are cups made of banana starch for easy and early decomposition when disposed. In another example, the biodegradable container are zipper lock bags.

In another embodiment of the invention, the container 250 are zipper lock biodegradable bags.

In still another embodiment, the container 250 are disposable garbage bags.

When an indication for the defecation is received by the SLAD 1000, the container releasing plate 220a is translated in X-direction via the linear drive actuator 225 to release the container 250 for the defecation process.

In another embodiment of the invention, the linear drive actuator 225 is controlled by the control unit 50 to control the translation of the container releasing plate 220a.

The released container 250 is now received by the container holding assembly 300 for transfer of containers 250 onto the container loading assembly 400.

FIG. 4B shows the container holding assembly 300 in detail. The container holding assembly 300 comprises a container holding plate 310 coupled to a stepper motor 320. The container holding plate 310 further comprises a plurality of recesses 315 to receive the container 250 from the container releasing assembly 200. The container holding plate 310 is a rotary disc configured to fix the container 250 at different assemblies.

The rotation of the stepper motor 320 rotates the container holding plate 310 to transfer the received container 250 in the recess to the container loading assembly 400 for further action. Simultaneously, a preceding recess (when viewed in the direction of rotation of the container holding plate 310) is positioned below the container releasing assembly 200 for loading a new container 250. The container holding assembly 300 further comprises a container ejection sheet 330 to eject the container 250 out of the recess.

According to another embodiment of the invention, the stepper motor 320 is controlled by the control unit 50 to rotate the container holding plate 310 for the transfer of the container 250 from the container releasing assembly 200 to the container loading assembly 400.

In yet another embodiment, the number of the plurality of recesses in the container holding plate 310 is equal to four (as shown in FIG. 3A). However, the number of recesses can be increased or decreased to suit the requirements. In one specific example, the plurality of recesses 315 are U shaped.

With reference to FIG. 5B, the container loading assembly 400 is now described in detail. The container loading assembly 400 comprises a vertical loading arm 410, a guide 415 having a mouth 415a. The vertical loading arm 410 and the guide 415 are attached to a backplate 420 and is configured to accommodate a container 250 between them (as shown in FIG. 5B). The container 250 is placed on the vertical loading arm 410 below the mouth 415a of the guide 410. The guide 415, is specifically designed for both male and female patients defecation. In one specific example (as shown), the mouth 415a is circular and has a diameter smaller than the diameter of the container 250. The smaller diameter is provided to dispose the fecal matter and the urine of the patient directly into the container 250, thereby preventing the spillage outside the container 250. In other example (not shown), the mouth 415a can be of any geometry other than the circular.

In another embodiment of the invention, the mouth 415a is washable, A small water jet tubing is provided from a tank configured in the SLAD 1000 to spray water for cleaning in-order to maintain the hygiene. The sprayed water runs off in the container 250 utilized during the defecation cycle and gets collected.

The rotation of the container holding plate 310 transfers the container 250 from the container releasing assembly 200 to position the container 250 onto the vertical loading arm 410. The container 250 received therein, is then translated vertically upwards in Y-axis. This upward translation enables the guide 415 to bud on the opening 23 (in the mid top portion 22) for the defecation cycle. The container 250 after defecation is translated vertically downwards in the recess of the container holding plate 310. In one specific example, the translation of the container 250 in vertically upward and vertically downward direction is enabled with the vertical loading arm 410, the guide 415, and the backplate 420, configured to move in a Y axis. The movement in Y-axis is enabled with the slider(s) configured to slide on the rail(s) 425 via a motor 430.

According to another embodiment of the invention, the motor 430 configured to enable the slider(s) slide on the rail(s) 425 is controlled by the control unit 50.

According to yet another embodiment of the invention, the wiping module (not shown) comprises the tissue holding assembly 500 andthe wiping assembly 600.

FIG. 6 shows the tissue holding assembly 500 utilized for cleansing process during the defecation cycle comprising the tissue holding arms 510a and 510b, a base plate 515, and a tissue holding compartment 550 (shown in FIG. 7). The tissue holding assembly 500 is configured to slide in X-axis, Y-axis, and Z axis for wiping the patient. The tissues for cleansing are loaded on the tissue holding arms 510a and 510b. Once the cleansing process is finished, the tissue is disposed in the same container 250 utilized during the defecation cycle.

In another embodiment of the invention, the cotton is kept inside the tissue holding compartment 550 for utilization in cleansing. A distilled water sprayer (not shown) sprays distilled water onto the cotton, thereafter picked by the tissue holding arms 510a, 510b. After utilization during cleansing process, the used cotton is disposed in the same container 250 utilized during the defecation cycle.

In yet another embodiment of the invention, the bidet module is utilized for cleansing process. Water is sprayed onto the anus and gets collected in the same container 250 utilized during the defecation cycle. Thereafter, the anus is sterilized with hot air blow.

In another embodiment of the invention, the tissue holding arms 510a and 510b are configured to slightly tilt on its longitudinal axis to clean the patient with unused side of the loaded tissue. In one specific example, the tilting of the tissue holding arms 510a, 510b is controlled by the control unit 50.

FIG. 7 shows the w1pmg assembly 600. The w1pmg assembly 600 comprises a supporting plate 610, a X-axis wiping plate 615, and a Y-axis wiping plate 620. The X-axis wiping plate 615 is configured to translate in X-direction on the supporting plate 610. The Y-axis wiping plate 620 is configured to translate on the X-axis plate 615 in Y-direction.

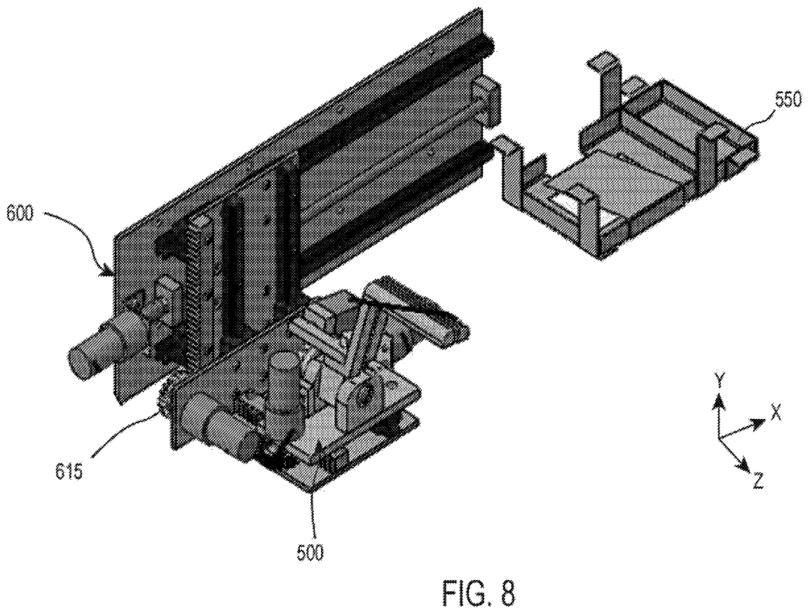

FIG. 8 shows the wiping assembly 600 with the tissue holding assembly 500 mounted thereon. The tissue holding assembly 500 is configured to translate on the Y-axis plate 615 in Z-direction.

In another embodiment of the invention, the translation of the X-axis plate in X-direction, the Y-axis plate in Y-direction, and the tissue holding assembly 500 in the Z-direction is enabled with the rack and pinion arrangements coupled to independent motors (as shown in the FIG. 8).

The tissue holding arms 510a, 510b picks the tissue staged in the tissue holding compartment 550. The tissues are utilized one by one with the help of a holder (not shown). The tissue loaded on the tissue holding arms 510a and 510b is raised to the patient's body level by the wiping assembly 600. The pre-configured movement of the tissue holding assembly 500 in X, Y, and Z direction, enabled with the wiping assembly 600, wipes clean the patient in the defecation cycle. In one specific example, the wiping assembly 600 is controlled by the control unit 50 to move the tissue holding assembly 500 on receiving the patient's input during the defecation cycle.

In another embodiment of the invention, the patient is further enabled to repeat the cleansing process. The control unit 50 is configured to receive the patient's input in the defecation cycle for repetition of the cleansing process.

According to yet another embodiment of the invention, a lid module (not shown) comprises the lid positioning assembly 700 and the lid closing assembly 800.

FIG. 9 shows the lid positioning assembly 700 comprising a lid base 710 with stacked plurality of container lids 720, and a container lid press plate 740. The container lids 720 are stacked in a lid holding box 725 offset to the container lid press plate 740. The lid positioning assembly 700 slides a container lid 720 towards the container 250 to position the container lids 720 above the container 250 arranged below the container lid press plate 740. The container lid press plate 740 presses the container lids 720 to lock the container 250.

In another embodiment of the invention, the sliding of the container lid 720 is enabled with a motor 750 controlled by the control unit 50.

FIG. 10B shows the exploded view of the lid closing assembly 800 comprising a lid closing base plate 810, and a lifting plate 820. The lifting plate 820 is configured to translate in a vertical direction by a lifting cam 830 coupled to a motor 840. A pair of guide rod 840 coupled to the lifting plate 820 are configured to slide in a pair of hollow support shaft coupled to the lid closing base plate 810, further facilitating the vertical translation of the lifting plate 820.

The lid closing assembly 800 assists the container lid press plate 740 for locking the container 250 with the container lid 720 by slightly lifting the container 250. The container lid 720 is positioned on the top of the lifted container 250 by the lid positioning assembly 700 and the container lid press plate 740 then presses the container lids 720 to lock the container 250.

According to another embodiment of the invention, the motor utilized to translate the lifting plate 820 in a vertical direction is controlled by the control unit 50.

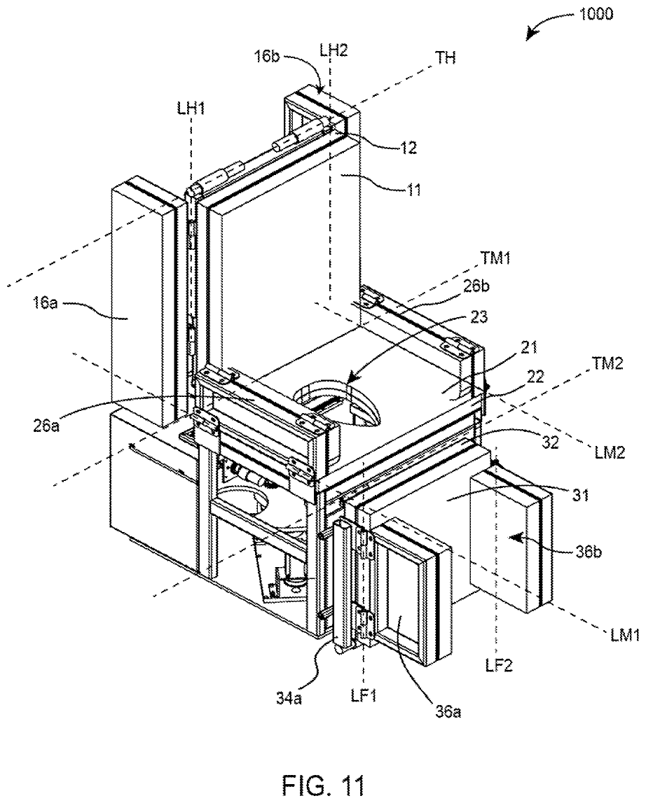

According to another embodiment of the invention, the SLAD 1000 has a bed mode and a wheelchair mode for assisting a patient for defecation. In the bed mode the SLAD 1000 is structured in the shape of a bed (as shown in FIG. 1A and 1B). On receiving a first indication by the patient, the SLAD 1000 orients automatically from the bed mode to a wheelchair mode thereby, structuring itself in the shape of a wheelchair (as shown in FIG. 11). In one specific example, the indication is received by the control unit 50 from the patient to orient the SLAD I 000 from the bed mode to the wheelchair mode.

### Bed Mode

Referring again to FIGURE I the bed mode is described in detail according to the embodiment of the invention. The SLAD I 000 in the bed mode is in the shape of a bed configured in a way that the head bottom portion 12, the head side spacers 16a and 16b, the mid bottom portion 22, the hand resting spacers 26a and 26b, the foot bottom portion 32, and the foot side spacers 36a and 36b form a rectangular shape to support the patient. The rectangular shaped configuration is raised above the ground by the head supporting frame 14 of the head portion assembly 10, the supporting frame 24 of the mid portion assembly 20, and the foot supporting frame 34 of the foot portion assembly 30. In one specific example, the legs 14a, 34a, and 14b, 34b are translated outwardly, away from the axes LH1, LF1 and the axes LH2, LF2 to support the head side spacers 16a, 16b and the foot side spacers 36a, 36b respectively. In another example, the head side spacers 16a, 16b, hand resting spacers 26a, 26b and the foot side spacers 36a, 36b have a stop configured to prevent rotation beyond a preset angle of rotation. In one specific example, the preset angle of rotation is 90 degree. In other examples, the preset angle of rotation is less than 90 degrees.

According to another embodiment of the invention in the bed mode, the pair of legs 14a and 14b of the head supporting frame 14 are aligned at the preset angle of rotation to the head bottom portion 12. In one specific example, as shown in FIG. 1B, the pair of legs 14a and 14b are aligned perpendicular to the head bottom portion 12 (or preset angle of rotation is 90 degrees). In another example (not shown), the legs 14a and 14b are at a preset angle of rotation is defined within the range from about 90 degrees to about 180 degrees.

In yet another embodiment of the invention, in the bed mode the plurality of legs of the supporting frame 24 are aligned at an angle to the mid bottom portion 22. In one specific example, the plurality of legs are perpendicular to the mid bottom portion 22. In another example (not shown), the plurality of legs are aligned at an angle defined within the range from about 90 degrees to about 180 degrees with respect to the mid bottom portion 22.

In yet another embodiment of the invention in the bed mode, the pair of legs 34a and 34b of the foot supporting frame 34 are aligned at a preset angle of rotation. In one specific example, as shown in FIG. 1, the pair of legs 34a and 34b are aligned perpendicular to the foot bottom portion 32 (or preset angle of rotation is 90 degrees). In another example (not shown), the legs 34a and 34b are aligned at a preset angle of rotation defined within the range from about 90 degree to about 180 degree.

### Wheelchair Mode

The wheelchair mode is now described in detail with reference to FIG. 11 according to the embodiment of the invention. The SLAD 1000, on receiving an indication from the patient, orients itself automatically in the shape of the wheelchair. The head bottom portion 12 in this mode, forms a backrest by rotating through the preset angle of rotation about the axis TM1 and the foot bottom portion 32 forms a leg rest by rotating through the preset angle of rotation about the axis TM2, thus making the mid bottom portion 22 the seating surface for the patient. In one specific example, the head bottom portion 12 and the foot bottom portion 32 are perpendicular to the mid bottom portion 22. In other example, the head bottom portion 12 and the foot bottom portion 32 are aligned at the preset angle of rotation less than 90 degrees. The hand resting spacer 26a and 26b forms the armrest by rotating through the preset angle of rotation about the axis LM1 and the axis LM2 respectively. The pair of legs 14a and 14b of the head supporting frame 14 are aligned rearwards to the head bottom portion 12. The pair of legs 34a and 34b of the foot supporting frame 34 are aligned with the foot bottom portion 32. The SLAD I 000 is now ready for the patient to defecate.

According to another embodiment of the invention, the defecation cycle is performed in the wheelchair mode to facilitate proper collection of the fecal matter of both male and female patient's. This further eliminates the spread or spillage during the defecation cycle.

In yet another embodiment of the invention, the control unit 50 is configured to receive patient's input for the defecation cycle. In one specific example, the number of defecation cycles for assisting the patient for defecation are ten. In other words, the number of times the SLAD I 000 can assist a patient automatically for defecation is ten, without any external assistance. In another example, the number of defecation cycles are customized according to the requirements. In one specific example, when the number of defecation cycle have been executed, the SLAD I 000 indicates an alert for maintenance of the SLAD 1 000 for proper hygiene.

In yet another embodiment of the invention, patient is configured to input the indication to the control unit 50 by input interfaces, such as a touchpad, keyboard, buttons, touchscreen, keypads and the like that preferably facilitate the entering of information. In one example, the buttons are push buttons. In other example, the buttons are lever operated. In still another example, the input interface can be a joystick.

In yet another embodiment of the invention, the SLAD 1000 is voice controlled. The patient gives voice commands to the SLAD 1000 to assist for defecation. The SLAD 1000 is enabled to respond to the voice commands of the patient for assisting.

In yet another embodiment of the invention, the voice commands are for the operation of the SALD 1000 for atleast one of the features including locomotion, wheelchair mode to bed mode (vice versa), defecation assistance, ramp climbing, medication and location tracker.

In yet another embodiment of the invention, the SLAD 1000 further comprises a sensor (not shown) configured to detect the bed mode and the wheelchair mode for the defecation cycle.

According to another embodiment of the invention, the control unit 50 comprises at least one of a microprocessor, a microcontroller, a memory module, a communication module, a user interface module, a PLC unit, a GPU, a display module, a timer, a counter, a monitoring means, a clock, a user identification module, or a combination thereof. An PLC can be changed into the embedded system.

In another exemplary embodiment, a smartphone application can be used to give a command to the control unit 50.

According to yet another embodment of the invention, the communication module comprises at least one of a NFC module, a Bluetooth module, a WiFi module, or a combination thereof.

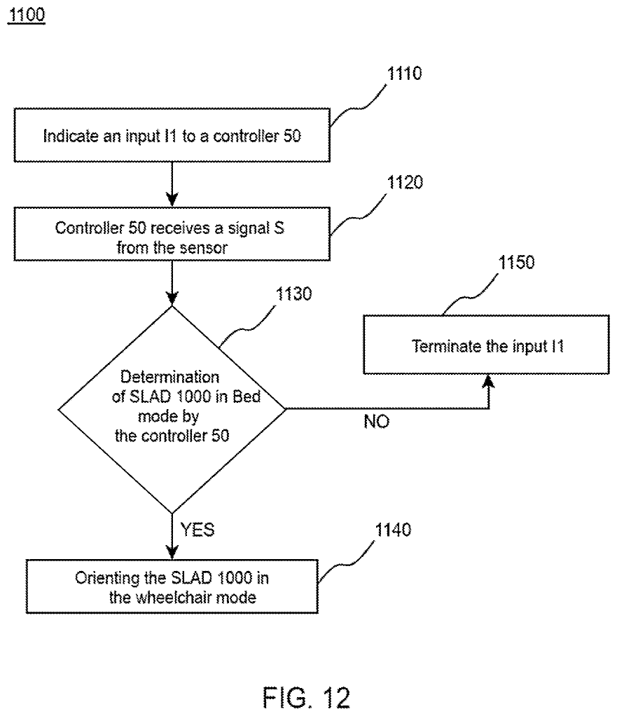

FIG. 12 schematically shows an example flow diagram of a method 1100 of using the SLAD 1000 in accordance with at least some embodiments described herein. The SLAD 1000 is in a bed mode or in the shape of a bed and describes the use by the patient for orienting in the wheelchair mode or in the shape of a wheelchair).

The method 1100 may include one or more operations, actions, or functions as illustrated by one or more blocks 1110, 1120, 1130, 1140, and 1150 in FIG. 12. Although illustrated as discrete blocks, various blocks may be divided into additional blocks, combined into fewer blocks, or eliminated, depending on the desired implementation. In some further examples, the variously described blocks may be implemented as a parallel process instead of a sequential process, or as a combination thereof.

At block 1110, the patient inputs an indication 11 to the control unit 50. The input is an indication for the orientation of the SLAD 1000 from a bed mode to the wheelchair mode.

At block 1120, the control unit 50 receives the signal S generated from the sensor. The signal S from the sensor is an indication of the bed mode or the wheelchair mode of the SLAD 1000.

At block 1130, determination is made for the bed mode of the SLAD 1000. The determination is made by the control unit 50 based on the received signal S. If the determination is positive, the control moves to block 1140. If the determination is negative, the control moves to block 1150 to terminate the indication 11 by the patient.

At block 1140, the control unit processes the indication 11 to orient the SLAD 1000 into the wheelchair mode. The SLAD 1000 structures itself automatically in the shape of a wheelchair.

According to yet another embodiment of the invention, the SLAD 1000 transfers the patient from one place to another in the wheelchair mode. The control unit 50 receives inputs from the patient and/or the caretaker for the transfer. In one example, the SLAD 1000 has an obstacle detection feature to detect the obstacle during the transfer. The obstacle is detected using a sensor, thereby stopping the SLAD 1000 and preventing the accident.

To add-on the distance from the obstacle can be measured. The movement ceases on the detection of the obstacle with an alert as an indication.

According to yet another embodiment of the invention, the SLAD 1000 has a safely belt to prevent front fall and for the safe climbing along the ramp.

According to yet another embodiment of the invention, the SLAD 1000 has an alarm or an indicator function provided for notifying necessary personnel an alert indicating the need to reload the container 250 in the container releasing assembly or the container lids 720 in the lid positioning assembly 700 or timely disposal of the locked container 250 from the storage compartment.

As shown in FIG. 11, the head bottom portion 12 forms a backrest by rotating through the preset angle of rotation about the axis TM1 and the foot bottom portion 32 forms a leg rest by rotating through the preset angle of rotation about the axis TM2, thus making the mid bottom portion 22 the seating surface for the patient. The hand resting spacers 26a and 26b form the armrest by rotating through the preset angle of rotation about the axis LM1 and the axis LM2 respectively. The pair of legs 14a and 14b of the head supporting frame 14 are aligned rearwards to the head bottom portion 12 by rotating through the preset angle of rotation about TH. The pair of legs 34a and 34b of the foot supporting frame 34 are aligned with the foot bottom portion 32 by rotating through the preset angle of rotation about the axis TF. The head side spacers 16a, 16b rotate through preset angle of rotation about the axis LH1, and the axis LH2 respectively. The foot side spacers 36a, 36b rotate through preset angle of rotation about the axis LF1, and the axis LF2 respectively.

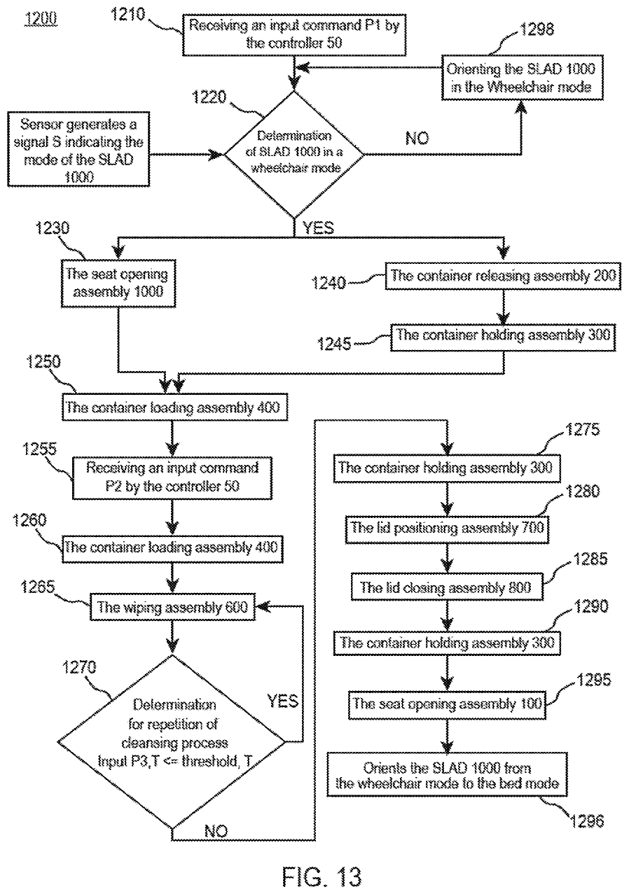

FIG. 13A schematically shows an example flow diagram 1200 illustrating the working of the SLAD 1000 in accordance with at least some embodiments described herein. The SLAD 1000 is in a wheelchair mode or in the shape of a wheelchair and describes the use by the patient for a defecation cycle.

The method 1200 may include one or more operations, actions, or functions as illustrated by one or more blocks 1210, 1220, 1230, 1240, 1245, 1250, 1255, 1260, 1265, 1270, 1275, 1280, 1285, 1290, 1295, 1296, and 1298 in FIG. 13. Although illustrated as discrete blocks, various blocks may be divided into additional blocks, combined into fewer blocks, or eliminated, depending on the desired implementation. In some further examples, the variously described blocks may be implemented as a parallel process instead of a sequential process, or as a combination thereof.

At block 1210, the control unit 50 receives a command P1. The command P1 is inputted by the patient for defecation.

At block 1220, the determination is made for the wheelchair mode of the SLAD 1000. The control unit 50 receives the signal S generated from the sensors. If the determination is positive the SLAD 1000 enters in a defecation cycle and the control proceeds to block 1230. If the determination is negative the control proceeds to block 1298 to orient the SLAD 1000 from the bed mode to the wheelchair mode for the defecation cycle. The control unit 50 now outputs a first command C1 to the seat opening assembly 100, a second command C2 to the container releasing assembly 200.

At block 1230, the seat opening assembly 100 (with respect to FIG. 2) uncovers the opening 23 in the mid bottom portion 12. The first command C1 outputted by control unit 50 is received at the motor 140 configured to translate the seat guide shaft(s) 120 in the X-axis. The seat guide shaft(s) 120 translate to lower the seat door 110. The seat guide shaft(s) 120 are further translated in the X-axis to move away the seat door 110 from the opening 23.

At block 1240, simultaneously, the second command C2 is received at the container releasing assembly 200. The command C2 indicates the release of the container 250 for the defecation process. The releasing plate 220a coupled to the linear drive actuator 225 translates to release the container 250 in the recess of the plurality of recesses 315 of the container holding assembly 300.

At block 1245, the container holding assembly 300 receives the container 250 in the recess. The control unit 50 now outputs a third command C3 to the stepper motor 320 to rotate the container holding plate 310 to position the received container 250 from the container releasing assembly 200 to the container loading assembly 400. The preceding recess, when viewed in the direction of rotation of the container holding plate 310, is positioned below the container releasing assembly 200. The control now proceeds to 1250.

In another embodiment, for every movement of the container holding plate 310 in the defecation cycle, the new container 250 is simultaneously positioned for the next consecutive defecation cycle. After the block 1245 is executed, the control unit 50 is programmed to release a new container 250 from the container releasing assembly 200 in the preceding recess of the container holding plate 310 for the consecutive defecation cycle. In the next consecutive defecation cycle the control of the flowchart 1200 skips the block 1245 to execute block 1250 because of the positioning of the container 250 in the previous defecation cycle.

The time interval to open the opening 23 by the seat opening assembly 100 is equal to the time interval taken by the container releasing assembly 100 to release the container 250 and the container holding assembly 300 to fix the container 250 onto the container loading assembly 400. The blocks 1230, 1240, and 1245 are executed in this manner to reduce the time of the defecation cycle.

According to another embodiment of the invention, the block 1230, 1240 and 1245 are executed in succession as discrete steps.

At block 1250, a third command C3 is outputted to the container loading assembly 400 to raise the container 250 and position below the opening 23. The container holding assembly 300 transfers the container 250 above the vertical loading arm 410 below the guide 415. The command C3 is now executed to translate the vertical loading arm 410 in Y-axis vertically upwards. The guide 415, after the translation of the vertical loading arm 410 has ended, contacts the mid bottom portion 12 below the opening 23.

The SLAD 1000 now exits the command control and the patient defecates. The fecal matter and the urine is collected in the container 250.

At block 1255, the control unit receives another command P2 from the patient. The command P2 indicates the end of defecation and the start of a cleansing process. The command P2 is executed by the control unit 50 by outputting another command C4 to the container loading assembly 400.

At block 1260, the command C4 is received at the container loading assembly 400. The vertical loading arm 410 is translated in vertically downward direction to position the container 250 in the recess of the container holding plate 310. The control unit 50 outputs another command CS to the wiping assembly 600 to start the cleansing process.

At block 1265, command CS is received by the wiping assembly 600 to wipe clean the patient after he/she has indicated the end of defecation. The tissue holding assembly 500 is moved in pre-configured X, Y, and Z direction by the wiping assembly 600. The tissue holding arms 510a and 510b loaded with the tissue from the tissue holding compartment 550 is raised to patient's body level. The X-axis wiping plate 615 moves the tissue holding assembly 500 in the X-direction. The Y axis wiping plate 620 moves the tissue holding arm 500 in Y-direction.

According to another embodiment, the tissue holding arms 510a, 510b are configured to tilt to clean with the unused side of the tissue. The tilting is enabled to effectively clean the patient during the cleansing process and maximize the use of the tissue. The tissue holding arms 510a, 510b are tilted by the control unit 50.

After the cleansing process has ended, the used tissue is disposed in the container 250 lowered at block 1260.

At block 1270, the determination is made for another command P3 from the patient indicating the repetition of the cleansing process. The control has a wait time T. If the wait time T exceeds a threshold time before the command P3 is inputted, the control moves towards end of the defecation cycle (terminates the command P3 inputted by the patient). If the command P3 is received within the threshold time, the control moves to block 1265 to repeat the cleansing process. The control now proceeds to block 1275 to end the defecation cycle. The command C6 is outputted by the control unit 50 to the container holding assembly 300.

According to another embodiment, after the block 1265 is executed, the patient inputs a command P4 to repeat the cleansing process. The patient inputs another command PS to the control unit 50 indicating to end the defecation cycle. The control now proceeds to block 1275.

At block 1275, the container holding assembly 300 receives the command C6 to rotate the container holding plate 310, thereby transferring the used container 250 from the container loading assembly 400 to the lid closing assembly 800.

The used container 250 is positioned below the container lid press plate 740 of the lid positioning assembly 700 and above the lifting plate 820 of the lid closing assembly 800. The control unit outputs a command C7 to the lid positioning assembly 700 and the control now proceeds to block 1280.

At block 1280, the command C7 is received by the lid positioning assembly 700 and executed. The container lid 720 is slid towards the container lid press plate 740, above the used container 250. The control unit outputs another command C8 to the lid closing assembly 800 and the control proceeds to block 1285.

At block 1285, the command C8 is received by the lid closing assembly 800. The used container 250 positioned above the lifting plate 820 is lifted against the container lid press plate 740 to lock the used container 250 with the container lid 720. The control unit outputs the command C9 to the container holding assembly 300 moving the control to block 1290.

At block 1290, the command C9 is received by the container holding assembly 300 to rotate the container holding plate 310, thereby transferring the locked container 350 towards the container ejection sheet 330. The locked container 250 is now ejected and stored in a storage compartment to end the defecation cycle. The control unit 50 now outputs a command C10 to seat opening assembly 100 to close the seat door 110.

At block 1295, the command C10 is received and processed by the seat opening assembly 100 to cover the opening 23 in the mid bottom portion 12. The seat door 110 moves to close the opening 23, thereby ending the defecation cycle.

At block 1296, the control unit 50 orients the SLAD 1000 from the wheelchair mode to the bed mode. In one specific example, the control unit 50 outputs a command C11, after the locked container 250 is ejected and stored, to change the mode of the SLAD 1000 from the wheelchair mode to the bed mode. In another example, the control unit 50 receives the command PS from the patient to orient in the bed mode.

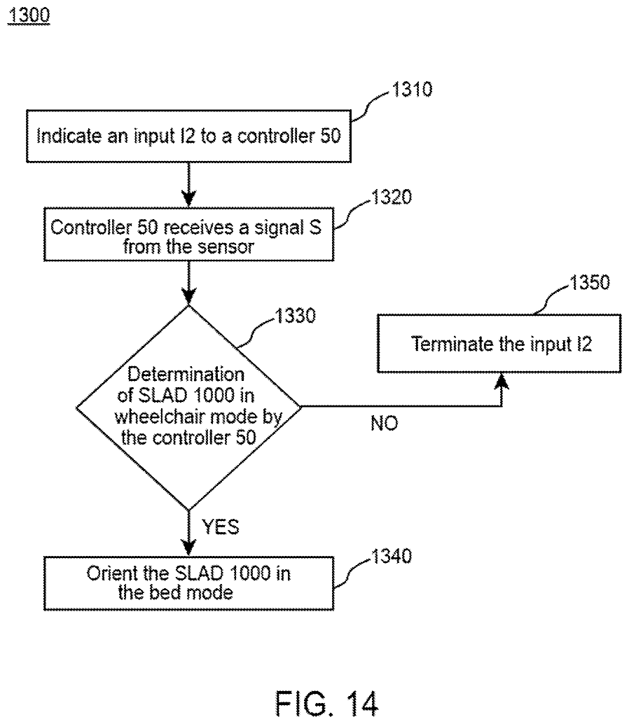

FIG. 14 schematically shows another example flow diagram of a method 1300 of using the SLAD 1000 in accordance with at least some embodiments described herein. The SLAD 1000 is in a wheelchair mode and describes the use by the patient for orienting into the bed mode. The wheelchair mode is converted to bed mode to reduce the back strain and the pressure produced.

The method 1300 may include one or more operations, actions, or functions as illustrated by one or more blocks 1310, 1320, 1330, 1340, and 1350 in FIG. 14. Although illustrated as discrete blocks, various blocks may be divided into additional blocks, combined into fewer blocks, or eliminated, depending on the desired implementation. In some further examples, the variously described blocks may be implemented as a parallel process instead of a sequential process, or as a combination thereof.

At block 1310, the patient inputs a indication 12 to the control unit 50. The input is an indication for the orientation of the SLAD 1000 from the wheelchair mode to the bed mode.

At block 1320, the control unit 50 receives the signal S generated from the sensor. The signal S from the sensor is an indication of the bed mode or the wheelchair mode of the SLAD 1000.

At block 1330, determination is made for the wheelchair mode of the SLAD 1000. The determination is made by the control unit 50 based on the received signal S. If the determination is positive, the control moves to block 1340. If the determination is negative, the control moves to block 1350 to terminate the indication 12 by the patient.

At block 1340, the control unit processes the indication 12 to orient the SLAD 1000 into the bed mode. The SLAD 1000 structures itself automatically in the shape of a bed.

As shown in FIG. 1 the head bottom portion 12, the head side spacers 16a and 16b, the mid bottom portion 22, the hand resting spacers 26a and 26b, the foot bottom portion 32, and the foot side spacers 36a and 36b form a rectangular shape by rotating through respective preset angle of rotation to support the patient. The pair of legs 14a and 14b of the head supporting frame 14 are aligned rearwards to the head bottom portion 12 by rotating through the preset angle of rotation about the axis TH. The pair of legs 34a and 34b of the foot supporting frame 34 are aligned with the foot bottom portion 32 by rotating through the preset angle of rotation about the axis TF. The rectangular shaped configuration is raised above the ground by the head supporting frame 14 of the head portion assembly 10, the supporting frame 24 of the mid portion assembly 20, and the foot supporting frame 34 of the foot portion assembly 30.

In an example, the patient converts the SLAD 1000 from the wheelchair mode into the bed mode to lie down without auxiliary support, thereby eliminating the transfer from wheelchair to bed.

According to another embodiment of the invention, the SLAD 1000 has a medication reminder to remind the patient for medication. In one example, the SLAD 1000 sends emergency alert to the caretaker/ward boys/nurses/guardian in cases of emergency.

According to yet another embodiment of the invention, the SLAD 1000 has a battery to draw electrical power for the working. In one example, the battery is rechargeable. In another example, the SLAD 1000 is coupled to an electrical power source in the room.

According to another embodiment of the invention, the SLAD 1000 has a location tracking feature. The caretaker/ward boys/nurses/guardians can track the patient using the SLAD 1000.

The “SMART LOCOMOTORY ASSISTIVE DEVICE” is an innovation in the field of rehabilitation and reduces the dependency of the patient on the caretakers. The present invention provides assistance to the patients by providing sturdy, safe for patients, efficient, and easy to use SLAD 1000. The SLAD 1000 as described in the present invention is robust (i.e. able to transfer the patient, operable with electricity as well as a rechargeable battery), reliable (i.e. long service life despite usage for hours/days/weeks), precise (i.e. pre-set components should not drift over time due to mechanical factors), and affordable.

Although the invention has been described with regard to its embodiments, specific embodiments, and various examples, which constitute the best mode presently known to the inventors, it should be understood that various changes and modifications as would be obvious to one having the ordinary skill in this art may be made without departing from the scope of the invention. The scope of the claims should not be limited by the preferred embodiments set forth in the examples, but should be given the broadest interpretation consistent with the description as a whole. All changes that come with meaning and range of equivalency of the claims are to be embraced within their scope.

We claim:

1. A smart locomotory assistive device for automatic defecation cleaning of a user, the device comprising:
a seat opening assembly configured to cover or uncover an opening for defecation;
a container handling module configured to operate at least one container, wherein the at least one container is configured to collect a fecal matter;
wherein the container handling module comprises a container releasing assembly, a container holding assembly, a container loading assembly or a combination thereof;
wherein the container holding assembly comprises a container holding plate having a plurality of recesses to receive the at least one container from the container releasing assembly;
a wiping module configured to perform a cleaning operation to the user, wherein said wiping module comprises:
(a) a tissue holding assembly configured to expose a cleaning material to perform the cleaning operation; and
(b) a wiping assembly configured to be mounted to the tissue holding assembly, wherein the wiping assembly is configured to cause the tissue holding assembly to move about at least one of three X, Y, and Z directions;
a lid module configured to close the at least one container using at least one lid; and
a control unit configured to activating the seat opening assembly, enabling the container handling module to place the at least one container to collect the fecal material, followed by allowing the wiping module to perform a cleaning operation to the user and/or allowing the lid module to close the at least one container by receiving an input from the user, thereby achieving an automatic defecation cleaning of the user.

2. The device of claim 1, wherein the seat opening assembly comprises a seat door pivotally connected to a seat guide shaft.

3. The device of claim 1, wherein the tissue holding assembly comprises at least one tissue holding arm, at least one base plate, at least one tissue holding compartment or a combination thereof.

4. The device of claim 3, wherein the at least one tissue holding arm comprises the cleaning material exposed thereon.

5. The device of claim 4, wherein the cleaning material is selected from tissues, wipes, clothes, paper clothes, or cotton.

6. The device of claim 1, wherein the lid module comprises a lid positioning assembly, a lid closing assembly or a combination thereof.

7. The device of claim 6, wherein the lid positioning assembly comprises at least one lid base with a stacked plurality of lids and at least one container lid press plate.

8. The device of claim 6, wherein the lid closing assembly assists the container lid press plate for locking the at least one container with the at least one lid.

9. The device of claim 1, wherein the device comprises a head portion, a mid portion and a foot portion.

10. The device of claim 9, wherein the seat opening assembly, the container handling module, the wiping module, the lid module and the control unit are installed on at least one selected from the head portion, the mid portion, the foot portion or combination thereof.

11. The device of claim 1, wherein the device is selected from a convertible bed cum chair, a bed, a chair, a wheelchair, a stretcher, or a gurney.

12. The device of claim 1, wherein the control unit is configured to operate, control and monitor the device using one or more sensors.

13. The device of claim 1, wherein the control unit is configured to receive the input by at least one input interface selected from a touchpad, keyboard, buttons, touchscreen, joysticks, keypads, or voice command.

14. The device of claim 1, wherein the container is a sealable biodegradable container.

15. The device of claim 1, further comprises a small water jet tubing to spray water for cleaning.
